(19) United States
(12) Patent Application Publication
(10) Pub. No.: US 2026/0086785 A1
(43) Pub. Date: Mar. 26, 2026

(54) REPOSITORY-LEVEL AUGMENTATION OF PROMPTS FOR CODE COMPLETION

(71) Applicant: Microsoft Technology Licensing, LLC, Redmond, WA (US)

(72) Inventors: Shengyu FU, Redmond, WA (US); Xiaoyu LIU, Sammamish, WA (US); Neelakantan SUNDARESAN, Bellevue, WA (US); Alexey SVYATKOVSKIY, Bellevue, WA (US)

(21) Appl. No.: 19/406,334

(22) Filed: Dec. 2, 2025

Related U.S. Application Data
(63) Continuation of application No. 18/141,212, filed on Apr. 28, 2023, now abandoned.

(51) Int. Cl. G06F 8/36; G06F 8/73

(52) U.S. Cl. CPC G06F 8/36; G06F 8/73

(57) ABSTRACT

A code completion system utilizes a large language model to complete a partially-formed source code snippet of a source code program given a prompt that includes a repository-level context, an extended context and a local context. The repository-level extended context includes a few-shot examples and a focal context. The few-shot examples are code fragments from the repository having a close similarity to the partially-formed source code snippet. The focal context includes method signatures and namespace information of methods of custom classes defined in the repository. The augmentation of the prompt with the various context data enables the model to predict more relevant code completion candidates for custom data without training the model on the custom data.

### CROSS-REFERENCE TO RELATED APPLICATIONS

This application is a continuation of U.S. application Ser. No. 18/141,212, filed Apr. 28, 2023, the entire contents of which is incorporated by reference herein in its entirety.

### BACKGROUND

Software development environments are often used to aid software developers (i.e., users, programmers, etc.) to develop program code. The software development environment may include a source code editor and other tools that a developer utilizes to write and test their programs. Some software development environments include a code completion feature that provides assistance while the developer is editing code by automatically presenting a list of possible candidates based on one or more characters (e.g., letters, symbols, etc.) that a developer has typed into a source code editor. A popup menu may appear with several suggested code elements that the developer may utilize. This assistance is beneficial since it speeds up the development time and reduces common errors, such as typos.

The code completion feature may utilize a large language model to predict candidates to complete a partially-formed source code snippet given the context of the partially-formed source code snippet. The large language model is often trained on a large-scale training dataset of source code to learn to predict the source code needed to complete the partially-formed source code snippet. The large-scale training dataset is often composed of source code from publicly-available code repositories. However, the large language model performs poorly when used with source code from private repositories containing source code having methods, classes, and types not seen in the training dataset.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A prompt, to a large language model for the generation of candidates to complete a partially-formed source code snippet, is augmented with a repository-level context consisting of a few-shot examples and a focal context. The large language model is pre-trained on publicly-accessible source code. The few-shot examples are code fragments from source code files of a private repository having a close similarity to the partially-formed source code snippet and which were not part of the training dataset of the large language model. The few-shot example includes data related to the code fragment, such as, suffix code that follows the code fragment and method signatures and namespace information associated with the method containing the code fragment.

The focal context includes method signatures and namespace information of methods of a custom class defined in the repository. The few-shot examples and the focal context in the prompt are used to guide the large language model on how to perform the code completion task without training the model on the task.

In addition, the prompt includes a local context and an extended context. The local context includes context from the current scope of a completion point and the extended context includes method signatures and namespace information defined in the file and not included in the local context.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a schematic diagram illustrating an exemplary system for repository-level context augmentation of prompts for code completion.

FIG. 2 is a schematic diagram illustrating an exemplary system for generating the repository (repo) database of few-shot examples.

FIG. 3 is a schematic diagram illustrating the search for the few-shot examples.

FIG. 4 is a schematic diagram illustrating an exemplary configuration of the large language model configured as a decoder neural transformer model with attention.

FIG. 5 is a flow diagram illustrating an exemplary method of the system for repository-level context augmentation of prompts for code completion.

FIG. 6 is a flow diagram illustrating an exemplary method for creating the repository database.

FIG. 7 is a flow diagram illustrating an exemplary method for generating code completion candidates.

FIG. 8 is a block diagram illustrating an exemplary operating environment.

### DETAILED DESCRIPTION

### Overview

Aspects of the present disclosure pertain to augmenting a prompt to a large language model for completion of a partially-formed source code snippet with repository-level context data from private repositories associated with the target source code program containing the partially-formed source code snippet.

Large language models trained for code completion typically leverage the context immediately preceding a current cursor position (i.e., completion point) or a partially-formed source code snippet. However, often the context needed to predict an accurate completion candidate may come from outside of the target source code program. It is critical to incorporate custom data (e.g., method signatures, methods, classes, namespaces) from private repositories, directories and/or projects not seen by the large language model in order for the model to predict relevant candidates.

The repository-level context data is incorporated into a prompt given to the large language model which guides the model toward generating candidates aligned with the custom context data. The repository-level context includes a few-shot examples and a focal context. The few-shot examples are code fragments from source code files of a private repository having a close similarity to the partially-formed source code snippet. The few-shot examples and the focal context in the prompt are used to explicitly guide the large language model on how it should perform the code completion task without training the model.

The focal context includes the method signatures and namespace information from the repository. A namespace is a declarative region that provides a scope to the identifiers (the names of types, functions, variables, etc.) inside it. Namespaces are used to organize code into logical groups and to prevent name collisions that can occur especially when the code base includes multiple libraries. The namespace information includes the module header/definitions, namespace definitions, and custom class definitions of the namespace.

The focal context includes method signatures and namespace information of methods of a custom class defined in the repository. The method signatures and namespace information of the methods of a custom class defined in the repository and invoked in the program are ordered based on distance from the invocation point to the completion point. The method signatures and namespace information of the methods of a custom class defined in the repository and not invoked in the program are added to the beginning of the prompt in a random order.

The prompt also includes an extended context and a local context. The extended context includes method signatures and namespace information of custom classes defined in the current file prioritized on the distance from the completion point. The local context includes the method signature of the method of the current cursor position and the method body of the method of the current cursor position up to the current cursor position.

The few-shot examples are stored in a repository database and are extracted from custom method signatures and namespace information contained in files of a private repository associated with the target source code program. Code fragments from the files of a repository are extracted along with their associated method signature and namespace information and stored in the repository database. An embedding of the code fragment is used to index each entry of the repository database. A search of the repository database is made to obtain the top-k code fragments and related data that are closest to a partially-formed source code snippet.

It should be noted that the description herein uses terms associated with the Python programming language. However, it should be noted that the techniques disclosed herein are not constrained to the Python programming language and can be applied to any programming language.

Attention now turns to a more detailed description of the system, method, and components for the extended augmentation of prompts for code completion.

### System

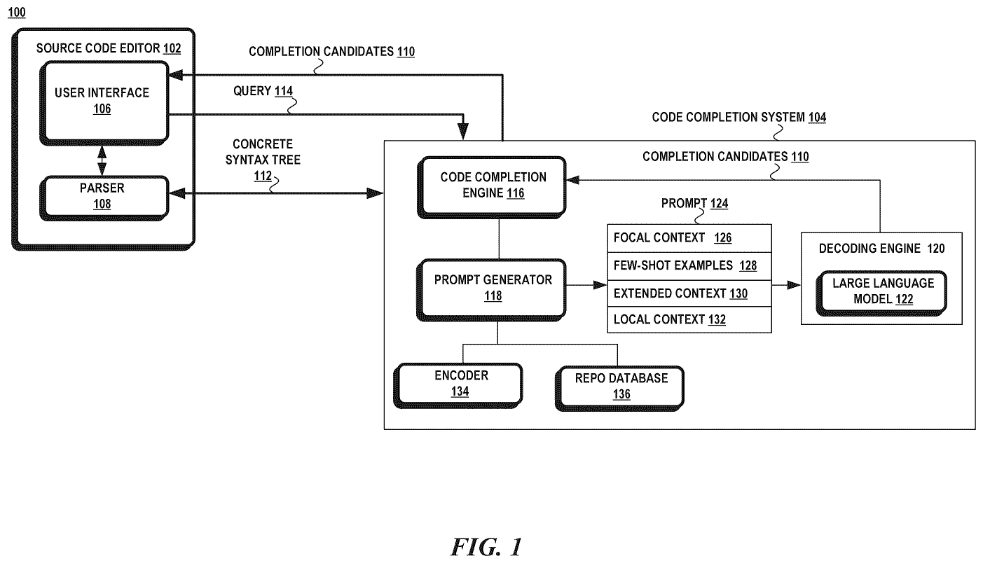

FIG. 1 illustrates a block diagram of an exemplary code completion system 100 for repository-level augmentation of prompts for code completion. The system 100 comprises a source code editor 102 and a code completion system 104.

The source code editor 102 may be part of an integrated development environment (“IDE”), application or tool used to develop, test, or maintain software. In one aspect, a source code editor 102 may include a user interface 106 and a parser 108. The user interface 106 includes a set of features or functions for developing (e.g., writing, editing, testing) a source code program. The user interface 106 may utilize a pop-up window to present a list of possible candidates 110 for completion thereby allowing a developer to browse through the candidates and to select one from the list. Alternatively, the candidates may appear in line with the current source code line as the user is typing characters into the source code program.

The parser 108 reads the characters entered into a source code program through the source code editor 102 and generates a corresponding concrete syntax tree 112. The parser 108 also updates the concrete syntax tree 112 as the developer creates and edits the source code in the source code editor 102.

At certain points in the editing process, the user interface 106 will request candidates to complete the source code at the current cursor position. The user interface may detect that the user has entered a particular character or string of characters and automatically initiate a request for candidates to complete a partially-formed source code snippet. This character is referred to as a marker character. The user interface 102 will then send a query 114 requesting candidates to present to the developer. Alternatively, the user may request candidates by entering a particular keystroke or sequence of keystrokes, such as the combination of the control (CTRL) key with the whitespace key.

In yet another aspect, the system may automatically display, in a dimmed color, a single top candidate at the end of the current source code line regardless of a marker character. The system builds and continuously updates a tree of candidates in the background regardless of whether the user decides to trigger the candidate or not. The candidate is automatically displayed in the user interface when the developer has been idle for a period of time. If the developer wants to accept the candidate, the developer may type in a particular keystroke or combination of keystrokes (e.g., CTRL and I) to accept the candidate. In this case, the cursor position will advance to the end of the suggested code sequence and the dimmed color of the candidate code will change to the normal color of the code. If the developer does not want to use the candidate, the candidate disappears when the user continues typing. In this case, the system would refine the code sequence based on the pre-fix filter of the tree of candidates based on the newly typed code.

The code completion system 104 tracks the characters that are input into the source code editor and services queries or requests 114 for candidates to complete code at the completion position. The code completion system 104 includes a code completion engine 116, a prompt generator 118, a decoding engine 120 and a large language model 122. The code completion engine 116 receives a query 114 for candidates to complete a partially-formed source code snippet and a concrete syntax tree 112 of the source code currently residing in the source code editor 102. The prompt generator 118 constructs a prompt 124 for the large language model 122 to autoregressively generate candidates to complete the partially-formed source code snippet. The candidates are ranked according to their respective probability with the candidates having the highest probability at the top. A select number of candidates 110 is then returned to the source code editor 102 and displayed in the user interface 106.

The prompt generator 118 generates the prompt 124 for the large language model 122 which includes a focal context, a few-shot examples, an extended context, and a local context. The prompt generator 118 utilizes an encoder 134 to generate encodings or embeddings of tokens of the source code snippet of the query which are used to search the repository database 136 to find the few-shot examples.

The decoding engine 120 performs a search for candidates to complete a partially-formed code snippet. To search through all possible candidate output sequences based on a probability is an intractable NP-complete search. Instead, the decoding engine uses a heuristic search algorithm that approximates the best candidates. The decoding engine 120 may utilize a beam search, nucleus sampling, random sampling, random sampling with temperature, and/or top-k sampling to generate the candidates.

In an aspect, the large language model 122 is a neural transformer model with attention configured with decoder blocks. The decoder neural transformer model with attention is pre-trained on source code programs and source code comments (i.e., natural language text). The decoder neural transformer model with attention is an auto-regressive model that produces an output one token at a time based on the outputs of previous time steps. Code completion is best suited for a decoder neural transformer model since it is an auto-regressive task that predicts an ordered sequence of tokens where the order depends on the preceding tokens in the sequence. Examples of a decoder neural transformer model with attention include GitHub's Copilot model, OpenAI's GPT models, and the like.

In an aspect, the large language model is a publicly-accessible model that is located on an external server. The decoding engine 120 may be situated on the same external server as the large language model or within the same computing device as the code completion engine. The code completion engine 116 communicates with the decoding engine 120 through Application Programming Interfaces (APIs) over a network.

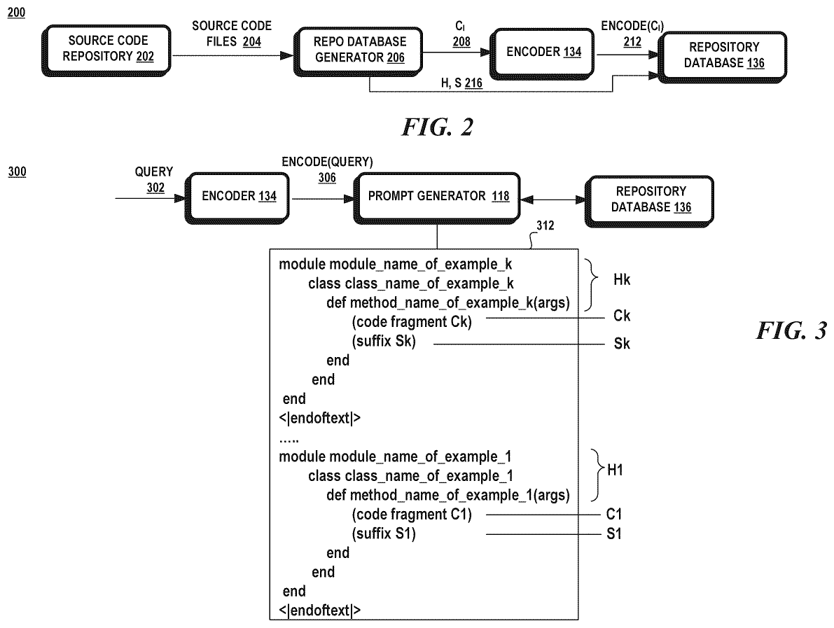

FIG. 2 illustrates a system 200 used to generate the repository (“repo”) database. Referring to FIGS. 1 and 2, the repository database 136 contains source code fragments from a related collection of files 204 used to create a software application or service that is not publicly-accessible. The related collection of files may be part of a source code repository or project associated with the source code program in the source code editor. A source code repository 202 is a file archive and web hosting facility that stores large amounts of source code privately. The source code repository 202 can be structured as a version control system, such as GIT, Mercurial, etc. A project of an IDE is a collection of files that are related, such as part of an application or service. The source code repository 202 and the project may include source code files, documentation files, scripts, tests, etc.

A repository database generator 206 extracts modules, classes and methods from the various files of the private repository 202. Code fragments are extracted from each file 204 of the repository 202. The files include modules, classes and methods used in various source code programs of the private repository. Each file in the repository database 202 containing source code is parsed into a concrete syntax tree. Byte pair encoding tokenization is used to extract code fragments from the concrete syntax tree that consist of a pre-configured size, such as 256 tokens. An encoder 134 is used to generate an embedding of the code fragment, Encode (Ci), which is used as an index to the repository database for the code fragment. Each entry in the repository includes the code fragment, Ci, its method signature and namespace information, H, and the lines of code following the code fragment, S.

FIG. 3 illustrates a system 300 used to extract the few-shot examples from the repository database. Referring to FIGS. 1 and 3, the system 300 utilizes the encoder 134, the prompt generator 118, and the repository database 136. The encoder 134 encodes a query 302 containing source code into an embedding, Encode (Query), which the prompt generator 118 uses to search the repository database 136 for closely matching embeddings. In an aspect, a cosine similarity is used to determine the similarity between the embedding of the query and the embedding of each code fragment in the repo database. The closest matching embeddings are used to extract the top-k code fragments, Ck, their associated method signatures and namespace information, Hk, and suffix continuation of the code fragment, Sk.

The top-k code fragments and related data are sorted by closest similarity as shown in block 312. Block 312 contains the top-k few-shot examples ordered in descending similarity. Each few-shot example contains namespace information and a method signature, Hi, the associated code fragment, Ci, and the suffix code following the code fragment Si until the end of a code block. As shown in block 312, the closest few-shot example contains namespace information consisting of a module header and signature, module_name_of_example_k, and a custom class definition, class_name_of_example_k, and the associated method signature, def method_name_of_example_k(args).

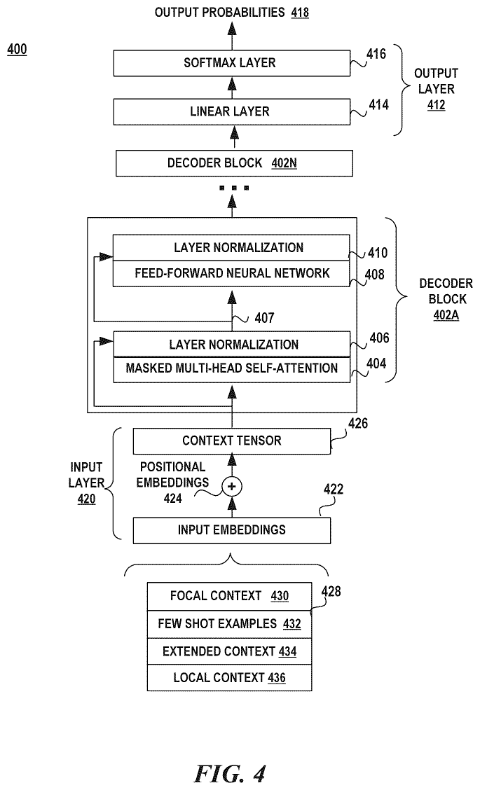

FIG. 4 illustrates an exemplary configuration of the large language model as a decoder neural transformer with attention. A large language model is a deep machine learning model that contains billions and more parameters. Parameters are the parts of the model learned from the training datasets that define the skill of the model to generate predictions for a target task.

A deep machine learning model differs from traditional machine learning models that do not use neural networks. Machine learning pertains to the use and development of computer systems that are able to learn and adapt without following explicit instructions, by using algorithms and statistical models to analyze and draw inferences from patterns in data. Machine learning uses different types of statistical methods to learn from data and to predict future decisions. Traditional machine learning includes statistical techniques, data mining, Bayesian networks, Markov models, clustering, support vector machine, and visual data mapping.

Deep machine learning differs from traditional machine learning since it uses multiple stages of data processing through many hidden layers of a neural network to learn and interpret the features and the relationships between the features. Deep machine learning embodies neural networks which differs from the traditional machine learning techniques that do not use neural networks. There are various types of deep machine learning models that generate source code, such as recurrent neural network (RNN) models, convolutional neural network (CNN) models, long short-term memory (LSTM) models, and neural transformers with attention.

The neural decoder transformer model 400 includes multiple stacked decoder blocks 402A-402N (“402”). The decoder 400 predicts each token ti in the target language one-by-one at each time step conditioned on all previously-generated target tokens t1, . . . ti−1. Each decoder block 402 consists of two layers. The first layer includes a masked multi-head self-attention component 404 followed by a layer normalization component 406. The output of the layer normalization component 406 is input into the second layer which includes a feed-forward neural network 408 with a residual connection to layer normalization component 410.

The masked multi-head self-attention component 404 receives the output embeddings of the previous timestep. The masked multi-head self-attention component 404 masks the output embeddings from future time steps. The feed-forward neural network 408 processes each output encoding separately. A layer normalization component 406, 410 is used between the layers in order to normalizes the inputs across the features.

The output layer 412 includes a linear layer 414 and a softmax layer 416. The linear layer 414 projects the vector produced by the stack of decoders into a logits vector. The softmax layer 412 then turns the scores of the logits vector into output probabilities for each token in the vocabulary V which are positive and normalized 418.

The input layer 420 to the first decoder block 402A includes an input embedding layer 422 containing embeddings of the input sequence, a positional embedding layer 424, and a context tensor 426. The positional embeddings 424 are used to retain the order of the tokens in the input sequence. The context tensor 426 contains the positional embeddings added to the input embedding 422.

During inference, the initial input to the first decoder block 404A contains a <START> token and the prompt 428 which includes the focal context 430, the few-shot examples 432, the extended context 434 and the local context 436. At each subsequent time step, the input is a shifted sequence of the output embeddings from the previous time step to which the positional embeddings are added forming context tensor 426.

### Methods

Attention now turns to a more detailed description of the methods used in the system. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

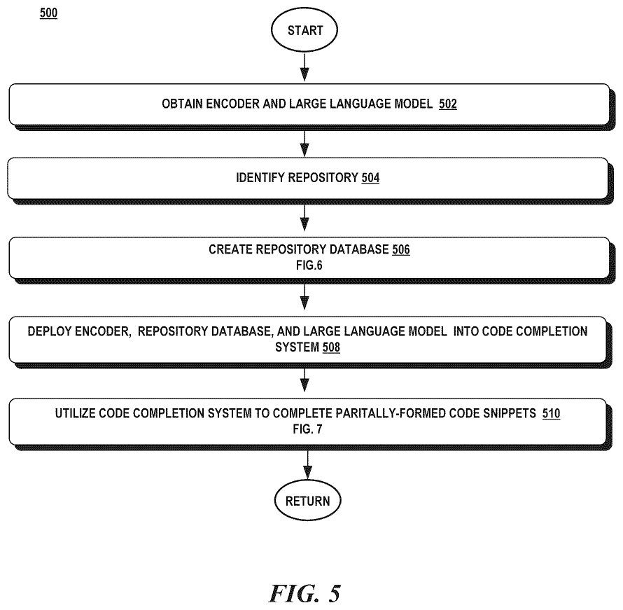

FIG. 5 is an exemplary method of the prompt generation system 500. Referring to FIGS. 1 and 5, a large language model 122 and an encoder 134 is obtained (block 502). In an aspect, the large language model 122 is a decoder neural transformer model with attention and the encoder 134 is an encoder neural transformer model with attention (block 502). A repository is identified (block 504) and a repository database 136 is generated for the repository (block 506). Upon completion of the generation of the repository database, the encoder 134, repository database 136 and large language model 122 are deployed in a code completion system 104 (block 508) for use in predicting candidates to complete a partially-formed source code snippet (510).

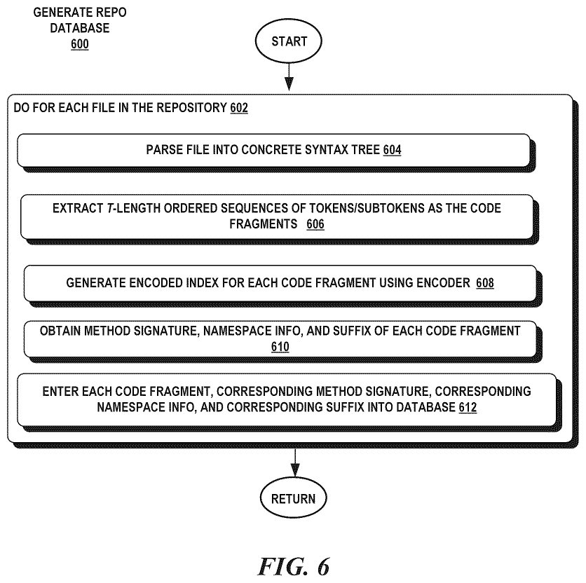

FIG. 6 illustrates an exemplary method 600 for generating a repository database for a specific repository. Referring to FIGS. 2 and 6, the method processes each file 204 in the source code repository 202 (block 602). The source code in each file is parsed into a concrete syntax tree (block 604). A sequence of T tokens and/or subtokens is extracted from the concrete syntax tree of a pre-determined length and considered a code fragment (block 606). The T-length ordered sequence of tokens of the code fragment is then mapped into numeric vectors and then into an embedding using the encoder 134 (block 608).

The method signature of the method containing the code fragment and the namespace information associated with the code fragment are obtained (block 610). The code fragment, the method signature of the method containing the code fragment and the namespace information associated with the code fragment are then stored in the repository database 136 indexed by the embedding 212 of the code fragment (block 612).

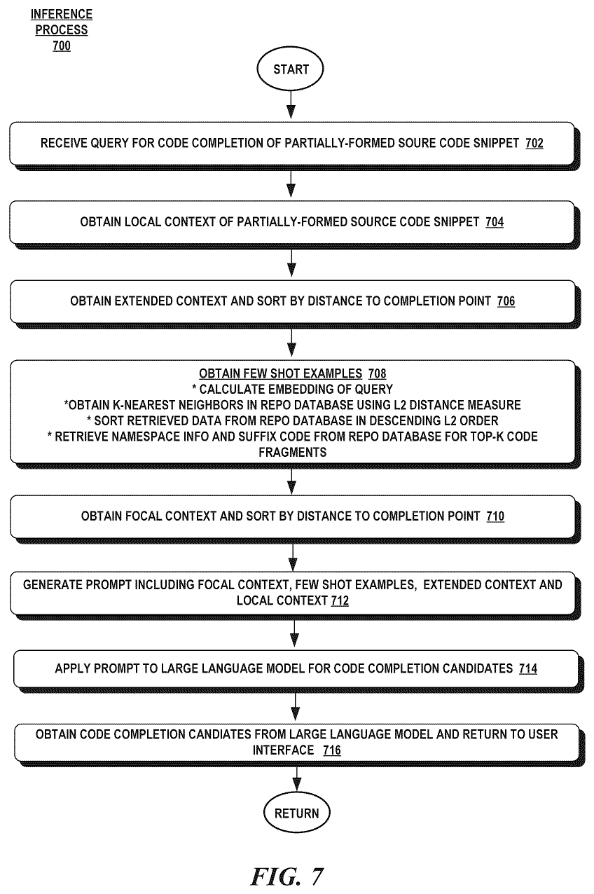

FIG. 7 is an exemplary method 700 of generating the prompt for the large language model. Referring to FIGS. 1 and 7, the code completion system 104 receives a query for candidates to complete a partially-formed code snippet (block 702). The query 114 consists of a pre-determined length of tokens preceding the current cursor position or completion point. The partially-formed code snippet may be a partially-formed method signature, partially-formed expression, partially-formed method body, and the like.

The prompt generator 118 obtains the local context 132, extended context 130, few-shot examples 128, and focal context 126. The local context 132 includes the method signature of the method of the completion point and the method body up to the completion point (block 704). The prompt generator 118 obtains the extended context which includes method signatures and namespace information defined in the current file outside of the local context (block 706). The extended context 130 is prioritized by the absolute line distance to the completion point in descending order (block 706).

The prompt generator 118 obtains the few-shot examples from the repository database (block 708). An embedding of the query, Encode(Q), is generated using the encoder, where Q is the query. The prompt generator 118 computes the cosine similarity between the embedding of the query and the embedding of each code fragment in the repository database 136. The cosine similarity measure or L2 normalized Euclidean distance computes the distance between two embeddings as the difference of the squared vector values, which is represented as:

L2(Q, ci)=¿|Encode(Q)−Encode(ci)|∨¿₂²¿, where Q is the query, and ci is the code fragment in the repo database.

The prompt generator 118 obtains the focal context which includes the method signatures and namespace information of methods of a custom class defined in the repository (block 710). The method signatures and namespace information of methods of a custom class defined in the repository and invoked in the program are prioritized based on a distance from the invocation point to the completion point. The method signatures and namespace information of methods of a custom class defined in the repository and not invoked in the program are randomly placed at the beginning of the prompt.

The prompt generator 118 then assembles the prompt in an order that includes the focal context 126, few-shot examples 128, extended context 130 and local context 132 (block 712). The prompt is sent to the decoding engine 120 which applies the prompt 124 to the large language model 122 (block 714). The large language model 122 interacts with the decoding engine 120 to generate completion candidates 110 which are then returned to the user interface 106 (block 716).

### Technical Effect/Technical Improvement

Aspects of the subject matter disclosed herein pertain to the technical problem of generating a prompt for a large language model to generate candidates to complete a partially-formed source code snippet having custom source code. The technical features associated with addressing this problem includes incorporating repository-level context into the prompt. The technical effect achieved is an increased accuracy of the predicted code completion candidates without the computational burden of training or fine-tuning the large language model on the custom source code.

The code completion system has to perform within tight timing requirements in order to be viable. In the scenario where the large language model resides on an external server that is accessed via a network, the operations used to generate the prompt need to be performed on a computing device. Hence, the operations performed are inherently digital. A human mind cannot interface directly with a CPU, or network interface card, or other processor, or with RAM or digital storage, to read and write the necessary data and perform the necessary operations and processing steps taught herein.

Embodiments are also presumed to be capable of operating “at scale”, that is capable of handling larger volumes, in production environments or in testing labs for production environments as opposed to being mere thought experiments.

The technique described herein is a technical improvement over prior solutions that utilized a local context as the prompt for a large language model or which fine-tuned the large language model with the custom data. The local context alone is not sufficient for the large language model to make predictions on private data. Fine-tuning a large language model with the custom data is not always possible due the considerable amount of resources needed to construct the fine-tuning data and the cost of fine-tuning a large language model. In some scenarios, it may not be possible to fine-tune a publicly-accessible large language model that has restrictions on its use. The augmentation of the prompt in the manner described herein avoids the costly fine-tuning step and improves the predictions by augmenting the prompt with the custom data.

### Exemplary Operating Environment

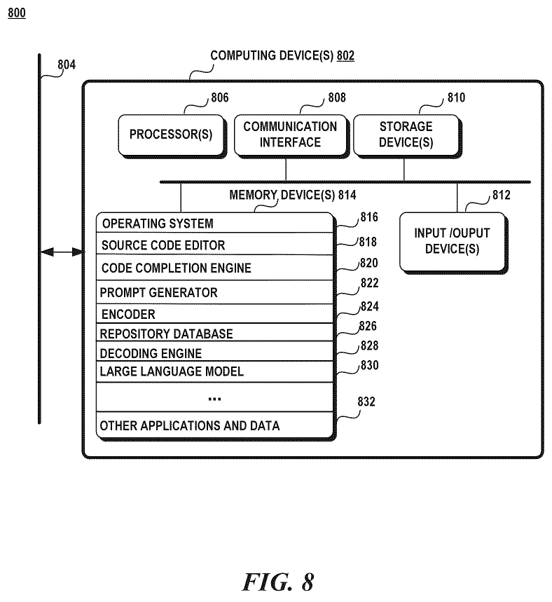

Attention now turns to a discussion of an exemplary operating environment 800. FIG. 8 illustrates an exemplary operating environment 800 in which one or more client computing devices 802 communicate with one or more computing devices. However, it should be noted that the aspects disclosed herein is not constrained to any particular configuration of the computing devices. In an alternate embodiment, the large language model be hosted on an external server and the code completion system hosted on a separate server. The code completion system communicates with the large language model over a network using APIs or the like.

A computing device 802 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 800 may be configured in a network environment, a distributed environment, a multi-processor environment, or a stand-alone computing device having access to remote or local storage devices.

A computing device 802 may include one or more processors 806, one or more communication interfaces 808, one or more storage devices 810, one or more memory devices or memories 814, and one or more input/output devices 812. A processor 806 may be any commercially available or customized processor and may include dual microprocessors and multi-processor architectures. A communication interface 808 facilitates wired or wireless communications between the computing devices and with other devices. A storage device 810 may be computer-readable medium that does not contain propagating signals, such as modulated data signals transmitted through a carrier wave. Examples of a storage device 810 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 810 in a computing device 802. The input/output devices 812 may include a keyboard, mouse, pen, voice input device, touch input device, display, speakers, printers, etc., and any combination thereof.

A memory device or memory 814 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 814 may also include one or more external storage devices or remotely located storage devices that do not pertain to propagated signals, such as modulated data signals transmitted through a carrier wave.

A memory device 814 may contain instructions, components, and data. A component is a software program that performs a specific function and is otherwise known as a module, program, and/or application. Memory device 814 includes an operating system 816, a source code editor 818, a code completion engine 820, a prompt generator 822, an encoder 824, a repository database 826, decoding engine 828, a large language model 830, and other applications and data 832.

The computing devices 802 may be communicatively coupled via a network 804. The network 804 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portion of the Public Switched Telephone Network (PSTN), plain old telephone service (POTS) network, a wireless network, a WiFi® network, or any other type of network or combination of networks.

The network 804 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra-Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### Conclusion

A system is disclosed comprising: one or more processors; and a memory that stores one or more programs that are configured to be executed by the one or more processors. The one or more programs including instructions to perform actions that: obtain a partially-formed source code snippet of a source code program, wherein the source code program is associated with a repository having a plurality of files; extract a local context of the partially-formed source code snippet, wherein the local context includes the partially-formed source code snippet; extract a repository-level context from the repository, wherein the repository-level context includes a plurality of few-shot examples and a focal context, wherein a few-shot example includes a code fragment from the repository having a close similarity to the partially-formed source code snippet, wherein the focal context includes method signatures of methods of custom classes defined in the repository, wherein the code fragment is outside of the source code program; create a prompt for a large language model to complete the partially-formed source code snippet, wherein the prompt includes the repository-level context and the local context; and generate from the large language model, given the prompt, at least one code completion candidate.

In an aspect, the focal context includes namespace information of methods of custom classes defined in the repository. In an aspect, the one or more programs include further instructions to perform actions that: rank the plurality of few-shot examples based on closest similarity to the partially-formed source code snippet; and select ones of the ranked few-shot examples having the closest similarity.

In an aspect, the one or more programs include further instructions to perform actions that: extract a method signature, namespace information and suffix code of each code fragment of each of the select ones of the ranked few-shot examples having the closest similarity to the partially-formed source code snippet; and augment the prompt with the extracted method signature, namespace information and suffix code for each of the select ones of the ranked few-shot examples.

In an aspect, the one or more programs include further instructions to perform actions that: extract an extended context from the source code program, wherein the extended context includes method signatures and namespace information of methods of custom classes defined in the source code program and outside of scope of the local context.

In an aspect, the one or more programs include further instructions to perform actions that: select ones of the extended context based on a closest distance to a completion point; and augment the prompt with the select ones of the extended context.

In an aspect, the local context includes a method signature of a method containing the partially-formed source code snippet and a method body of the method containing the partially-formed source code snippet.

In an aspect, the large language model is a neural transformer model with attention.

A computer-implemented method is disclosed, comprising: obtaining a partially-formed source code snippet from a source code program, wherein the source code program is associated with a repository having a plurality of files; extracting a local context of the partially-formed source code snippet, wherein the local context includes a context of the partially-formed source code snippet; extracting a repository-level context from the repository, wherein the repository-level context includes at least one few-shot example extracted from the repository and a focal context, wherein the at least one few-shot example has closest similarity to the partially-formed source code snippet, wherein the focal context includes method signatures of methods of custom classes defined in the repository; and generating from the large language model, given a prompt having the repository-level context and the local context, at least one code completion candidate to complete the partially-formed source code context.

In an aspect, the computer-implemented method further comprises: augmenting the focal context with namespace information of the methods of the custom classes defined in the repository. In an aspect, the namespace information includes module definitions, namespace definitions and custom class definitions of the methods of the custom classes defined in the repository.

In an aspect, the context of the partially-formed source code snippet includes a method signature of the method containing the partially-formed source code snippet and a method body of the method containing the partially-formed source code snippet.

In an aspect, the at least one few shot example includes a code fragment similar to the partially-formed source code snippet, a method signature of a method containing the code fragment, namespace information of the code fragment and suffix code following the code fragment.

In an aspect, the focal context includes method signatures of methods of custom classes defined in the repository and not invoked in the source code program. In an aspect, the focal context includes method signatures of methods of custom classes defined in the repository and invoked in the source code program.

In an aspect, the computer-implemented method further comprises: prioritizing the focal context with the method signatures of methods of custom classes defined in the repository and not invoked in the source code program over the method signatures of methods of custom classes defined in the repository based on distance from invocation point to completion point.

A computer-implemented method is disclosed comprising: accessing a large language model over a network to predict code completion candidates for a partially-formed source code snippet, wherein the partially-formed source code snippet is associated with a repository having a plurality of files; accessing a database of few-shot examples, wherein a few-shot example includes a code fragment from the repository, suffix code following the code fragment, and method signatures and namespace information associated with the code fragment; selecting ones of the few-shot examples having a code fragment closely similar to the partially-formed source code snippet; extracting a focal context for the partially-formed source code snippet containing method signatures and namespace information of methods of custom classes defined in the repository; extracting a local context of the partially-formed source code snippet; constructing a prompt including the focal context, the select ones of the few-shot examples, and the local context of the partially-formed source code snippet; transmitting the prompt to the large language model for a code completion candidate to complete the partially-formed source code snippet; and receiving from the large language model the code completion candidate.

In an aspect, the large language model is a neural transformer model with attention. In an aspect, the computer-implemented method, further comprises: augmenting the prompt with an extended context of the partially-formed source code snippet, wherein the extended context includes method signatures of methods of custom classes defined in the source code program and outside of the scope of the local context. In an aspect, the focal context is prioritized based on a distance from an invocation point to a completion point, and the extended context is prioritized based on a distance from the invocation point of the methods of custom classes defined in the source code program and the completion point.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It may be appreciated that the representative methods described herein do not necessarily have to be executed in the order presented, or in any particular order, unless otherwise indicated. Moreover, various activities described with respect to the methods can be executed in serial or parallel fashion, or any combination of serial and parallel operations.

What is claimed:

1. A system comprising:
a processor; and
a memory that stores instructions that are configured to be executed, the instructions being configured to perform actions including:
obtain a partially-formed source code snippet of a source code program to complete, wherein the source code program is associated with a private repository comprising custom data defined in the private repository, wherein the custom data comprises custom classes;
extract a local context of the partially-formed source code snippet from the source code program, wherein the local context includes the partially-formed source code snippet;
search for a few-shot example, of a plurality of few-shot examples from the private repository, wherein the few-shot example comprises a code fragment from the private repository, outside of the source code program, the few-shot example, of the plurality of few-shot examples from the private repository, having a closest similarity to the partially-formed source code snippet;
extract a focal context for the partially-formed source code snippet from the private repository, wherein the focal context comprises method signatures of methods of the custom classes defined in the private repository;
generate a repository-level context from the private repository, wherein the repository-level context includes the few-shot example and the focal context;
create a prompt for a large language model trained on publicly-accessible source code, the prompt including instructions to complete the partially-formed source code snippet, wherein the prompt includes the repository-level context and the local context; and
cause the large language model, given the prompt, to generate at least one code completion candidate that completes the partially-formed source code snippet.

2. The system of claim 1, wherein the focal context includes namespace information of the methods of the custom classes defined in the private repository.

3. The system of claim 1 wherein the actions further include:
rank the plurality of few-shot examples based on a similarity of each few-shot example of the plurality of few-short examples with the partially-formed source code snippet; select a subset of the plurality of few-shot examples based on the ranking of each few-shot example based on the similarity with the partially-formed source code snippet extract a method signature, namespace information and suffix code of each code fragment of the subset of the plurality of few-shot examples; and
augment the prompt with the method signature, namespace information and suffix code extracted for each code fragment of the subset of the plurality of few-shot examples.

4. The system of claim 1, wherein the actions further include:
extract an extended context from the source code program, wherein the extended context includes method signatures and namespace information of the methods of the custom classes defined in the source code program and outside of scope of the local context.

5. The system of claim 4, wherein the actions further include:
select the extended context based on a distance to a completion point; and
augment the prompt with the selected ones of the extended context.

6. The system of claim 1, wherein the local context includes a method signature of a method containing the partially-formed source code snippet and a method body of the method containing the partially-formed source code snippet.

7. The system of claim 1, wherein the large language model is a neural transformer model with attention.

8. A computer-implemented method, comprising:
obtaining a partially-formed source code snippet from a source code program to complete, wherein the source code program is associated with a private repository comprising custom data and publicly-accessible source code, wherein the custom data is defined in the private repository and comprises custom classes;
extracting a local context of the partially-formed source code snippet from the source code program, wherein the local context includes a context of the partially-formed source code snippet;
searching for a few-shot example, of a plurality of few-shot examples from the private repository, wherein the few-shot example comprises a code fragment from the private repository, outside of the source code program, the few-shot example, of the plurality of few few-shot examples from the private repository, having a closest similarity to the partially-formed source code snippet;
extracting a focal context for the partially-formed source code snippet from the private repository, wherein the focal context comprises method signatures of methods of the custom classes defined in the private repository;
generating a repository-level context from the private repository, wherein the repository-level context includes the few-shot example and the focal context; and
sending a prompt to a large language model trained on publicly-accessible source code, the prompt including instructions that cause the large language model to complete the partially-formed source code snippet, the prompt including the repository-level context and the local context.

9. The computer-implemented method of claim 8, further comprising:
augmenting the focal context with namespace information of the methods of the custom classes defined in the repository.

10. The computer-implemented method of claim 9, wherein the namespace information includes module definitions, namespace definitions and custom class definitions of the methods of the custom classes defined in the repository.

11. The computer-implemented method of claim 8, wherein the local context of the partially-formed source code snippet includes a method signature of a method containing the partially-formed source code snippet and a method body of the method containing the partially-formed source code snippet.

12. The computer-implemented method of claim 8, wherein the few-shot example includes a method signature of a method containing the code fragment of the few-shot example, namespace information of the code fragment of the few-shot example and suffix code following the code fragment of the few-shot example.

13. The computer-implemented method of claim 8, wherein the focal context includes method signatures of the methods of the custom classes defined in the private repository and not invoked in the source code program.

14. The computer-implemented method of claim 13, wherein the focal context includes method signatures of the methods of the custom classes defined in the private repository and invoked in the source code program.

15. The computer-implemented method of claim 14, further comprising:
prioritizing the focal context with the method signatures of the methods of the custom classes defined in the private repository and not invoked in the source code program over the method signatures of the methods of the custom classes defined in the private repository based on a distance from an invocation point to a completion point.

16. A computer-implemented method, comprising:
identifying a partially-formed source code snippet associated with a private repository having private data and publicly-accessible source code;
accessing a database of few-shot examples, wherein each few-shot example of the few-shot examples includes a code fragment from the private repository;
selecting a few-shot example from the database of few-shot examples based on a similarity of the few-shot example to the partially-formed source code snippet;
extracting a focal context for the partially-formed source code snippet containing method signatures and namespace information of methods of custom classes defined in the private repository;
extracting a local context of the partially-formed source code snippet;
constructing a prompt including the focal context, the selected few-shot example, and the local context of the partially-formed source code snippet;
transmitting the prompt to a large language model trained on publicly-accessible source code, the prompt including instructions for the large language model to provide a code completion candidate to complete the partially-formed source code snippet; and
receiving from the large language model the code completion candidate.

17. The computer-implemented method of claim 16, wherein the large language model is a neural transformer model with attention.

18. The computer-implemented method of claim 16, further comprising:
augmenting the prompt with an extended context of the partially-formed source code snippet, wherein the extended context includes method signatures of methods of custom classes defined in the source code program and outside of a scope of the local context.

19. The computer-implemented method of claim 18,
wherein the focal context is prioritized based on a distance from an invocation point to a completion point, and
wherein the extended context is prioritized based on a distance from an invocation point of methods of custom classes defined in the source code program and the completion point.

20. The computer-implemented method of claim 16, wherein the method includes receiving a plurality of different code completion candidates in response to the prompt.
